(19) United States
(12) Patent Application Publication
(10) Pub. No.: US 2008/0264384 A1
(43) Pub. Date: Oct. 30, 2008

(54) Plug-in pump fuel injection system

(76) Inventors: Rolf Kusterer, Fellbach (DE); Andreas Radtke, Stuttgart (DE); Ralf Schoble, Stuttgart (DE)

Correspondence Address: KLAUS J. BACH, 4407 TWIN OAKS DRIVE, MURRYSVILLE, PA, 15668, US

(21) Appl. No.: 12/148,290

(22) Filed: Apr. 17, 2008

Related U.S. Application Data
(63) Continuation-in-part of application No. PCT/EP2006/009752, filed on Oct. 10, 2006.

(30) Foreign Application Priority Data
Oct. 20, 2005 (DE) 10 2005 050 233.4

(51) Int. Cl. F02M 69/04

(52) U.S. Cl. 123/445

(57) ABSTRACT

In a plug-in pump fuel injection system of an internal combustion engine, wherein for each cylinder of the internal combustion engine a plug-in fuel injection pump is provided, each having a pump housing with a fuel feed channel and a fuel return channel, an annular plate provided with openings is arranged in a circumferential groove of the fuel return channel which extends around the pump housing of each plug-in pump and which forms a part of the fuel return channel of the respective plug-in fuel pump in order to inhibit the formation of pressure oscillations in the fuel return channel.

This is a Continuation-In-Part Application of pending international patent application PCT/EP2006/009752 filed Oct. 10, 2006 and claiming the priority of German patent Application 2005 050 233.4 filed Oct. 20, 2005.

### BACKGROUND OF THE INVENTION

The invention relates to a plug-in pump fuel injection system of an internal combustion engine wherein each cylinder has its own exchangeable fuel injection pump.

DE 196 00 565 C1 discloses a plug-in pump fuel injection system of this type for an internal combustion engine, wherein each cylinder of the internal combustion engine has a plug-in fuel injection pump, that is an individually exchangeable fuel injection pump for injecting fuel into a respective cylinder. The plug-in fuel pump can also be called an individual injection pump. Each of the plug-in pumps of a plug-in pump fuel injection system has a pump housing with a fuel feed channel and a fuel return channel.

When the plug-in pumps of a plug-in pump fuel injection system of this type are actuated, pressure peaks which negatively influence the filling behavior or the filling process of the plug-in pumps can be formed as a result of the high injection pressures in the fuel feed channel and in the fuel return channel. It is known from the prior art that in plug-in pump injection these systems pressure waves are generated which cause oscillations and thus ultimately can impair the filling process of the plug-in fuel pumps.

It is the principal object of the present invention to provide a novel plug-in pump fuel injection system which inhibits the formation of such detrimental pressure waves.

### SUMMARY OF THE INVENTION

In a plug-in pump fuel injection system of an internal combustion engine, wherein for each cylinder of the internal combustion engine a plug-in fuel injection pump is provided, each having a pump housing with a fuel feed channel and a fuel return channel, an annular plate provided with openings is arranged in a circumferential groove of the fuel return channel which extends around the pump housing of each plug-in pump and which forms a part of the fuel return channel of the respective plug-in fuel pump.

The formation of disruptive pressure waves and oscillations in the fuel return channel can be minimized at the plug-in fuel injection pumps with the aid of the annular plate with the result that an optimum filling behavior of the plug-in fuel injection pumps is obtained. The annular plate may also be called a baffle plate.

The invention will become more readily apparent from the following description of an exemplary embodiment of the invention with reference to the accompanying drawings.

### BRIEF DESCRIPTION OF THE DRAWINGS

FIG. 1 shows a pump of a plug-in pump fuel injection system, and

FIG. 2 shows an annular plate, which is provided with openings, of the plug-in pump fuel injection system.

### DESCRIPTION OF AN EXEMPLARY EMBODIMENT

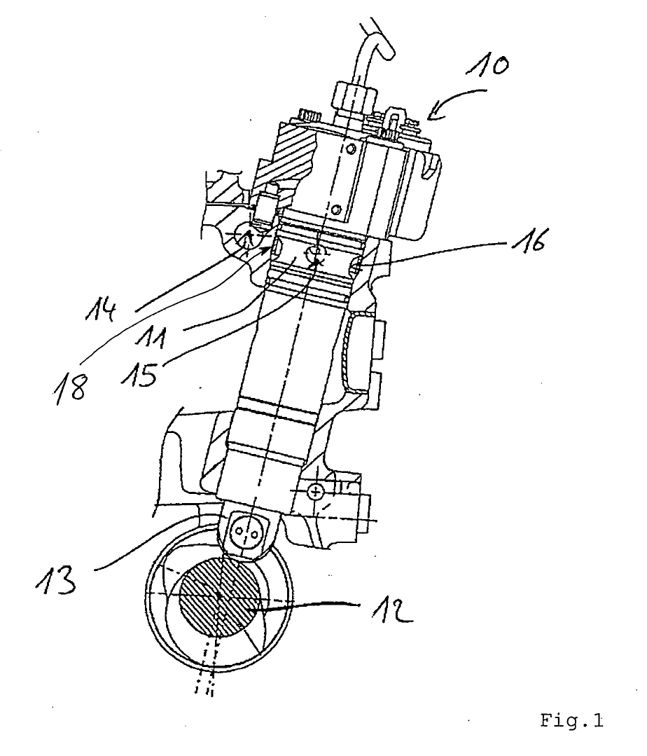

FIG. 1 shows a detail of a plug-in pump fuel injection system in the region of a plug-in fuel injection pump 10, each cylinder of an internal combustion engine being assigned a separate plug-in fuel injection pump 10. Each plug-in fuel injection pump 10 has a pump housing 11, a pump plunger (not shown) which is actuated via a roller tappet 13 which interacts with a pumping piston which is guided in the pump housing 11 and is operated by the roller tappet 13 co-operating with a camshaft 12. With regard to the structural design and the operation of plug-in pumps 10 of this type, reference is made at this point to DE 196 00 565 C1, the content of which is explicitly referred to hereby.

A fuel feed channel 14 and a fuel return channel 15 are formed in the region of the pump housing 11 of each plug-in pump 10. The fuel return channel 15 is defined at least in sections by a circumferential groove 16 which is formed in an outer wall of the pump housing 11.

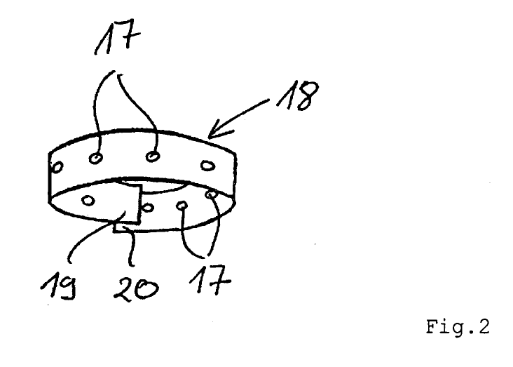

In the context of the present invention, an annular plate 18 which is provided with recesses 17 is assigned to each plug-in pump 10 in order to ensure an optimized filling behavior of the plug-in pumps 10. The annular plate 18 is accommodated positively in the circumferential groove 16 in the outer wall of the pump housing 11 of the respective plug-in pump 10. FIG. 2 shows an annular plate 18 which is provided with recesses 17 and, in the context of the present invention, is inserted into the circumferential groove 16 of the pump housing 11 of the plug-in pump 10 according to FIG. 1.

The annular plate 18 which is provided with recesses 17 is formed from spring steel and is severed at one circumferential position, with the result that two free ends 19 and 20 are formed which are disposed opposite one another. The annular plate 18 is accordingly configured in the manner of a clip. In order to insert the annular plate 18 which is provided with recesses 17 into the groove 16, the plate 18 is bent apart in the region of the ends 19 and 20 and is introduced or clipped or snapped into the groove 16 of the pump housing 11 in the bent-apart state. The plate 18 is held automatically in the groove 16 as a result of the restoring action of the plate 18 which is produced from spring steel and as a result of the positive engagement of the plate 18 in the groove 16.

As has already been mentioned, openings 17 are provided in the annular plate 18 in the preferred exemplary embodiment. The openings 17 ensure that a fuel return channel 15 is not blocked. The openings 17 are preferably made in the annular plate 18 at an identical spacing from one another. It is to be noted at this point that the openings 17 of the annular plate 18 can also be configured as cut-outs or slots which extend into the plate 18 from an upper edge or a lower edge thereof.

What is claimed is:

1. A plug-in pump fuel injection system of an internal combustion engine having a number of cylinders, each cylinder of the internal combustion engine being provided with a plug-in fuel injection pump (10), each having a pump housing (11) with a fuel feed channel (14) and a fuel return channel (15) including a circumferential groove (16) formed in the pump housing (12), and an annular plate (18) provided with openings (17) arranged in the circumferential groove (16) which forms a part of the fuel return channel (15) of the pump housing (11) of the respective plug-in pump (10) so as to inhibit the formation of pressure oscillations in the fuel return channel (15).

2. The plug-in pump fuel injection system as claimed in claim 1, wherein the annular plate (18) which is provided with openings (17) is formed from spring steel.

3. The plug-in pump fuel injection system as claimed in claim 1, wherein the annular plate (18) which is provided with openings (17) is severed at one circumferential location, so that said annular plate (18) can be bent open in the manner of a clip for insertion into the circumferential groove (16) of the pump housing (11) of the respective plug-in fuel pump (10).

4. The plug-in pump injection system as claimed in claim 1, wherein the annular plate (18) which is provided with openings (17) is guided positively in the groove (16) of the pump housing (11) of the respective plug-in pump (10).

5. The plug-in pump fuel injection system as claimed in claim 1, wherein the annular plate (18) is a perforated plate having a plurality of openings (17) which are spaced uniformly apart from one another.
